(19) United States
(12) Patent Application Publication
(10) Pub. No.: US 2020/0234377 A1
(43) Pub. Date: Jul. 23, 2020

(54) System for Processing Insurance Transactions

(71) Applicant: Galileo Platforms Limited, Sheung Wan (HK)

(72) Inventors: Mark Wales, Sheung Wan (HK); Matt Crooks, Sheung Wan (HK); Yu Ham, Sheung Wan (HK)

(21) Appl. No.: 16/259,757

(22) Filed: Jan. 28, 2019

(30) Foreign Application Priority Data
Jan. 21, 2019 (HK) 19101038.1

(51) Int. Cl. G06Q 40/08; G06Q 20/38

(52) U.S. Cl. CPC G06Q 40/08; G06Q 2220/00; G06Q 20/389; G06Q 20/3829

(57) ABSTRACT

There is provided a system for processing insurance transactions and a processing server of an insurer and a provider.

A provider processing server stores encrypted agreements between an insurer and provider for the payment for the provision of a plurality of specified services to customers. The server appending to a distributed electronic ledger with an encrypted customer service request upon receiving a request by a customer having a unique identifier for at least one of the specified services.

An insurer processing server receives and electronically stores an encrypted insurance policy for a customer with a unique identifier covering a plurality of predefined services. The server monitors the distributed electronic ledger and detects a customer service request for a customer from a provider with whom that insurer has an encrypted agreement. Upon identification in an insurance policy for the specified customer of coverage for the specified services, an encrypted approval transaction is appended to the distributed electronic ledger.

### FIELD

The present disclosure relates to the use of distributed ledger technology in an insurance context.

### BACKGROUND

Despite improvement in various systems and technology which have been deployed for the processing and management of claims of insured persons especially once claims have been lodged, many of the initial interactions between the insurer, the insured and the provider of a service rely on manual processing, oversight and auditing. This is time consuming and inefficient with lengthy delays in claims processing due to unnecessary duplication of effort. Auditing and compliance regulatory oversight may require retention of paper forms, some of which may be provided by an insurer to the provider at a nominal cost per form.

This is especially the case in the provision of insurance coverage by an insurer to insured persons for particular services, including health consultations. In this environment in an out-patient scenario, health insurance providers such as medical clinics or specialists rely upon the provision of a policy number of the insured (usually from a card carried by the patient). This number may be included on a form setting out details of the relevant diagnosis and treatment. In an in-patient scenario, and based upon the coverage details associated with a specific insured; a pre-approval up to a specified limit may be provided by the insurer to the provider in advance of the treatment being performed. In the in-patient scenario, once the treatment has been performed and/or the patient discharged; the approval may then be processed as a claim, with excess or gap being funded by the patient.

In addition to significant inefficiencies in the interface between insured, insurers and providers, typically the insured must provide details of their policy to the provider in order for the provider to claim directly from the insurer. Multiple insurance policies with different insurers may potentially cover insured persons with or without their knowledge, leading to the potential for inadvertent or deliberate claim duplication by an insured. In addition, the inefficiencies in the system enable payments by the insurer to be delayed, therefore potentially creating cash flow problems for the providers.

There have been various attempts to address the deficiencies in the above, including building a claims processing management system which consolidates the various documents from providers and insurers into a centralised provider for multiple providers and multiple insurers however this has added yet a further layer of complexity and inefficiency to the process, as well as being vulnerable to attack by nefarious individuals seeking to exploit weaknesses of such a system.

It is an object of the present disclosure to provide a system and method which addresses or ameliorates at least some of the above problems.

### SUMMARY

Features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims.

In accordance with a first aspect of the present disclosure, there is provided a system for processing insurance transactions comprising:

at least one provider processing server configured for storing at least one or more encrypted agreements with at least one insurer for the payment for the provision of a plurality of specified services to customers; wherein the at least one provider processing server is further configured for appending to a distributed electronic ledger with an encrypted customer service request upon receiving a request by a customer having a unique identifier for at least one of the specified services;

at least one insurer processing server for receiving and electronically storing an encrypted insurance policy for a customer with a unique identifier wherein said policy covers provision of a plurality of predefined services; the insurer processing server being configured for monitoring the distributed electronic ledger and detecting a customer service request for a customer from a provider with whom that insurer has an encrypted agreement; and upon identification in an insurance policy for the specified customer of coverage for the specified services in the customer service request, appending an encrypted approval transaction to the distributed electronic ledger.

Optionally, the provider processing server may be configured for encryption of the agreements with a private key and the insurer processing server may be configured for encrypting the insurance policy with customers with a private key.

The provider may be a health services provider and the customer may be a patient of the provider.

The insurer processing server may be configured to analyse benefit history following identification in an insurance policy for the specified customer to confirm coverage for the specified services prior to approval of the request for services. The coverage for specified services may be confirmed after reviewing the benefits already claimed under the insurance policy for the specified customer.

The provider processing server may be configured for detecting and decrypting approvals from a plurality of insurers having encrypted contracts with that provider, said approvals being for a customer of the specified services being appended transactions on the distributed electronic ledger.

The encrypted agreements may be concluded from an unencrypted master agreement accessible across a computer network.

Provider modification to a customer service request may be encrypted prior to updating of the distributed electronic ledger for approval by at least one insurer processing server against the policy for the provision of a plurality of predefined services of the customer having the unique identifier.

The insurer processing server may be further configured for generating an encrypted claim from the approval of the provider for updating the distributed electronic ledger.

The encrypted claim may be reviewed by the insurer prior to being assigned for payment.

The encrypted claim may include at least one or more encrypted documents associated with the claim whereby the location of these documents is propagated via appending to the distributed ledger. The documents may be downloaded and verified by the insurer's processing server

Advantageously, information on the distributed ledger originating from a provider for a specific insurer is able to be decrypted only by that insurer with a corresponding private encryption key and wherein the provider is unable to access policy information for the customer having the unique identifier.

Optionally, the encrypted claim is paid by the insurer module of the processing server

Advantageously, a processing server may be configured to accrue a plurality of encrypted claims for a specific insurer of a plurality of insurers for consolidated payment thereof.

A bank payment server may be coupled to the computer system via a communications network configured for receiving a payment request from an insurer for transfer of funds.

In a further aspect of the disclosure, there is provided a service provider processing server of a system for processing insurance transactions, the processing server comprising

at least one storage module for storing at least one or more encrypted agreements by the provider with at least one insurer for the payment for the provision of a plurality of specified services to customers,

a user interface for receiving a request from a customer having a unique identifier for at least one of the specified services,

a distributed ledger interface module for updating a distributed electronic ledger with an customer service request which has been encrypted by an encryption module, wherein the distributed ledger interface module is further configured to monitor the distributed electronic ledger so as to detect an encrypted approval of the customer service request from an insurer processing server.

The processing server may be configured for detecting and decrypting approvals from a plurality of insurers having encrypted contracts with that provider, said approvals being for a customer of the specified services appended to the distributed electronic ledger.

Provider modification to a customer service request is encrypted prior to updating of the distributed electronic ledger for approval by at least one insurer processing server against the policy for the provision of a plurality of predefined services of the customer having the unique identifier.

In still a further aspect of the present disclosure, the insurer processing server may comprise at least one storage module for receiving and electronically storing an encrypted insurance policy for a customer with a unique identifier wherein said policy covers provision of a plurality of predefined services;

a distributed ledger interface module for detecting a customer service request in a distributed ledger for a customer from a provider with whom that insurer has an encrypted agreement; and upon identification in an insurance policy for the specified customer of coverage for the specified services in the customer service request, being configured for updating the distributed electronic ledger with an encrypted approval transaction.

A user interface module may be configured to enable manually approving a customer service request for a customer having a unique identifier upon identification in an insurance policy for the specified customer of coverage for the specified services in the customer service request.

Optionally, the processor of the insurer processing server may be configured to analyse benefit history following identification in an insurance policy for the specified customer to confirm coverage for the specified services prior to approval of the request for services.

The insurer processing server may be further configured for generating an encrypted claim from the approval of the provider detected on the distributed electronic ledger and writing the encrypted claim thereto.

The encrypted claim may be reviewed by the insurer prior to being assigned for payment.

The encrypted claim may include at least one or more encrypted documents associated with the claim whereby the location of these documents is propagated via appending to the distributed ledger. Advantageously, the documents are downloaded and verified by the insurer's processing server.

Preferably, the information on the distributed ledger originating from a provider for the insurer may be able to be decrypted only with a corresponding private encryption key held by the insurer and wherein the provider is unable to access policy information for the customer having the unique identifier.

A payment processing server may be configured to accrue a plurality of encrypted claims for that insurer prior to payment at a predetermined time.

In still a further aspect of the present disclosure, there is provided a computer program product embedded in a non-transitory medium comprising instructions executable one or more computer processors of one or more computers of a plurality of computers coupled to a network to

store at least one or more encrypted agreements with at least one insurer for the payment for the provision of a plurality of specified services to customers;

append to a distributed electronic ledger an encrypted customer service request upon receiving a request by a customer having a unique identifier for at least one of the specified services;

receive and electronically store an encrypted insurance policy for a customer with a unique identifier wherein said policy covers provision of a plurality of predefined services; and

monitor the distributed electronic ledger and detect a customer service request for a customer from a provider with whom that insurer has an encrypted agreement; and upon identification in an insurance policy for the specified customer of coverage for the specified services in the customer service request, append an encrypted approval transaction to the distributed electronic ledger.

In yet a further aspect there may be provided a method for processing insurance transactions comprising:

storing at least one or more encrypted agreements of a provider with at least one insurer for the payment for the provision of a plurality of specified services to customers;

updating a distributed electronic ledger with an encrypted customer service request upon receiving a request by a customer having a unique identifier for at least one of the specified services;

storing an encrypted insurance policy for a customer with a unique identifier wherein said policy covers provision of a plurality of predefined services;

monitoring the distributed electronic ledger and detecting a customer service request for a customer from a provider with whom that insurer has an encrypted agreement;

identifying in an insurance policy for the specified customer of coverage for the specified services in the customer service request, updating the distributed electronic ledger with an encrypted approval transaction.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings.

Preferred embodiments of the present disclosure will be explained in further detail below by way of examples and with reference to the accompanying drawings, in which:—

FIG. 1a depicts an exemplary high level schematic architecture of an embodiment of the system of the present disclosure.

FIG. 1b depicts an exemplary schematic architecture of an exemplary processing server of the system depicted in FIG. 1a.

FIG. 1c depicts an exemplary architecture for sharing a document in off chain storage across the distributed ledger in the system depicted in FIG. 1a.

FIG. 2 depicts an exemplary high level flow for electronic transactions processed in accordance with the exemplary embodiments of the present disclosure.

FIG. 3 depicts a detailed flow of exemplary stages of claim assessment and approval.

FIG. 4 depicts a detailed flow of exemplary stages of a services claim.

FIG. 5a depicts an exemplary flow of group accrual for payment of claims.

FIG. 5b depicts the exemplary stages in the payment process for the group accrual of claims depicted in FIG. 5a.

FIG. 5c depicts exemplary stages in payment of uncovered individual items.

FIG. 6 depicts separation of data access rights according to an exemplary embodiment shown in FIG. 1a.

FIG. 7 depicts various stages in collections disbursement and payments according to an exemplary embodiment of the system depicted in FIG. 1a.

### DETAILED DESCRIPTION OF THE PREFERRED EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for an automated multi-party management system using distributed ledger technology in various aspects of the insurance process.

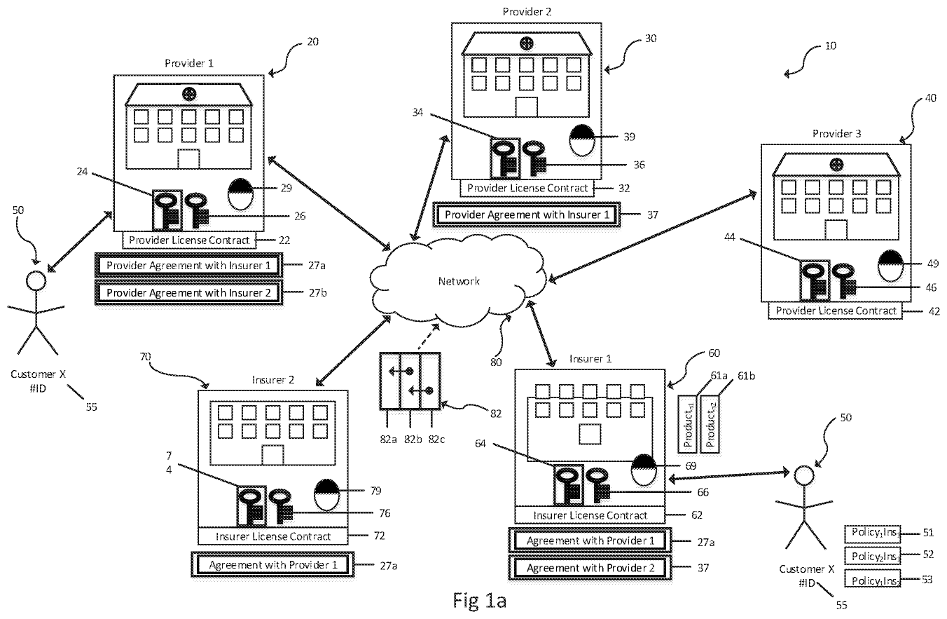

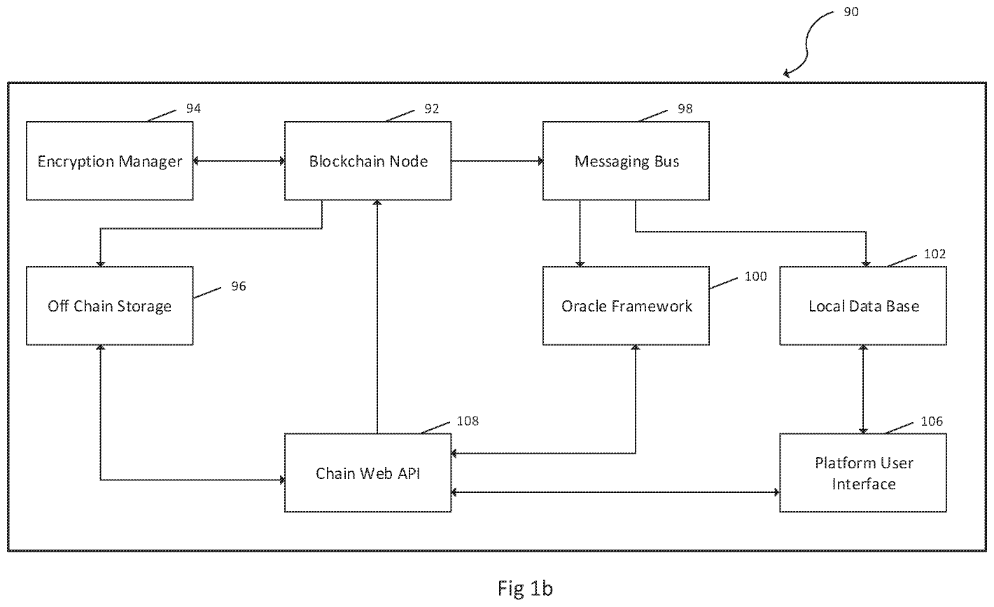

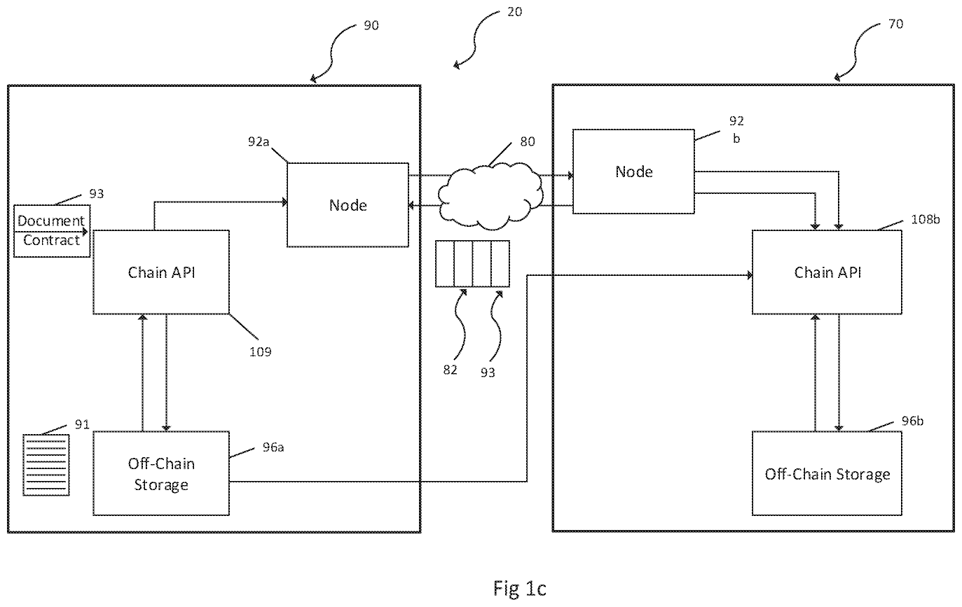

Referring to the drawings, there is shown in FIG. 1a an exemplary schematic view of a distributed transaction system 10 in which there exists three providers 20, 30, 40 which may provide services to a customer 50 who may have insurance with any or both of the two insurance providers 60, 70 depicted. Processing servers of these entities are in electronic communication across a distributed network 80. Advantageously, a distributed network ledger 82 of a series of historical transactions in “blocks” 82a, 82b, 82c may be appended as various transactions are updated on the distributed ledger via the nodes (processing servers) connected to the network 80.

The providers 20, 30, 40 each have their own publicly accessible Provider License Contract 22, 32, 42 which is visible to and accessible by all participants in the system 10 without encryption. The provider License Contract could specify the type of services which could be provided by that provider. Price information may be manually entered when a Services Situation is raised by a provider (described in more detail in due course).

Each provider 20, 30, 40 has a private key 24, 34, 44 (which is secret and known only to the provider) together with a corresponding public key 26, 36,46 for encryption for performing digital transactions on the network 80. This is discussed in more detail below.

Similarly, insurance provider 1 and insurance provider 2 (respectively 60, 70) each have an Insurer License contract (which specifies what the insurer is licensed to do in a jurisdiction). 62, 72 which is publicly available to all participants of the system 10. Again, the insurance provider 60, 70 each have their own private key 64, 74 and a corresponding public key 66, 76 for encrypting and decrypting digital transactions on the distributed network 80.

In the embodiment depicted, an agreement for provision of services has been concluded between Provider 1 and Insurer 1—27a—and between Provider 1 and Insurer 2—27b. Agreement 27b is accessible only by Provider 1 and Insurer 1, and cannot be accessed by any entities on the platform in view of the encryption which has been performed.

Similarly, Provider 2 has concluded an agreement with Insurer 1 only—Item—37; whereas Provider 3 has no concluded agreements with any insurers in the system 10.

Insurer 1 60 has a suite of products 61a, 61b. Each product sets out the structure of coverages which will be provided including benefits paid out, limitations, terms and condition of the coverage provided. The coverages may be specific to particular jurisdictions.

In a health care context, the insurer may be providing health insurance and may have certain coverages and payment amounts agreed for certain conditions, treatments etc.

Policies 51, 52, 53 for specific products 61a, 61b are concluded by an insurer with a person 50 (whether in a co-insured, insured or similar role) and are encrypted by the corresponding insurer's private key 64, 74 such that they are not accessible only to that insurer and not to any other entities on the network.

In the example depicted, the customer 50 has concluded Policy 1 with Insurer 1 51, Policy 2 with Insurer 1 (item 52) as well as Policy 3 with Insurer 3 (item 53). Each customer may be identified with a unique identifier 55, which may be an identification number, passport number, social security number or the like.

Each of the entities in the system are hosted on nodes or processing servers 29,39,49,59,69 which are in electronic communication and append a transaction in the distributed ledger 82 across the network 80. A chain of providers may share a node, or each of the chain of providers may have separate nodes depending on the needs of the providers.

Similarly, an insurer may be hosted on the same or separate nodes.

Advantageously, the present system may be deployed in a health care context in which the person (or related entity) 50 may be receiving health care treatments provided by one or more of the providers 20,30,40 in the event that they are sick or injured.

However, it should be appreciated that the disclosure is not limited to the specific health care setting described, and is equally applicable to other types of insurance claim processing.

Accordingly, in a health care context the nodes or processing servers may host multiple providers for example multiple separate hospitals, or clinics within the same group, or each hospital/clinic may be hosted on separate nodes.

It would be appreciated that the entities and arrangements depicted in FIG. 1a are exemplary only; and many modifications of the specifics of this would be possible without departing from the scope of the present disclosure. For example, multiple agreement contracts may be concluded with multiple providers; with multiple policies issued to multiple persons—all of which have been omitted from the representation provided for clarity purposes.

Furthermore it would be appreciated that the various agreements between service providers and insurers for the performance of services may be concluded using smart contracts on the system 10.

Referring to FIG. 1b there is depicted a high level representation of a typical node or processing server 90 representative upon which the entities depicted in FIG. 1a may be hosted.

As depicted Blockchain module 92 connects the processing server (node) 90 to the network 80 and manages the propagation of the transactions on the distributed electronic ledger 82; where such transactions may acted upon by other processing servers (nodes) connected to the network. It is appreciated that where reference is made in the present disclosure to updates to the distributed ledger such updates are processed by way of appending the transaction to the ledger in view of the immutable nature of the distributed ledger.

The Encryption module 94 manages the encryptions of the transactions before propagation via the Blockchain module 92 onto the distributed electronic ledger 82. As is known in the art, transactions are encrypted using asymmetric encryption so only the parties to a transaction can retrieve the transaction using the appropriate private key.

Referring to the various entities depicted in FIG. 1a this is described in more detail. In an example, assume processing server (node) 90 (for example Provider 1-29) needs send encrypted contract information to another node (for example Insurer 1-69) across the network 80, using the distributed ledger 82.

The Oracle 100 or Chain Web API 108 of node 29 retrieves the counterparties public key 66 from the counterparty's License contracts (62 i.e. local contract on insurer node or 27a being the license version on provider node) and provides it to the Encryption Manager module 94.

The Encryption Manager Module of the processing server 29 Provider 1 (item 60) creates the transaction specifying this transaction is Private. The Encryption Manager Module uses its own public key 26 and the public key 66 of its counterparty Insurer 1 60.

Upon seeing a private transaction, the blockchain node 92 of the provider processing server (node) 69 passes the transaction payload to the Encryption Manager module 94. The Encryption Manager module 94 encrypts the transaction by:
Generating a symmetric key;
Generating a nonce;
Encrypts the transaction payload and the nonce using the symmetric key.
Generates a hash of the result
Encrypts the symmetric key using the public key of all parties.

The hash, encrypted payload and encrypted symmetric key is transmitted directly to the Encryption Manager module 94 of each participant with a public key listed for the transaction.

The Encryption manager module 94 passes the hash to the blockchain node 92. The blockchain node 92 replaces the transaction payload with the hash. The transaction containing the Private For list and the hash is propagated on the distributed ledger 82 across the network 80 to all participants.

Upon receiving the transaction in a block, the blockchain node module 92 for each node specified as a participant in that transaction (including the originator) passes the hash to their respective Encryption Manager module 94. Each Encryption Manager module 94 uses the hash to identify the appropriate transaction payload it has previously received. In particular each Encryption manager module 94 uses the hash to decrypt the symmetric key and the symmetric key to decrypt the transaction payload.

Each Encryption Manager module 94 of the respective processing servers (nodes) involved in the transaction returns the encrypted transaction content to its respective Blockchain Node 92. Each Blockchain Node 92 reconstructs the transaction and executes the transaction in its own Virtual Machine. It would be appreciated by persons skilled in the art that this is one method of encryption and other methods in the art could be performed without departing from the scope of the present disclosure.

An Off-chain storage module 96 may be used to hold structured and unstructured information not stored directly on the distributed ledger.

A Messaging Bus module 98 manages the distribution of transactions from the Blockchain module 92 to other modules of the processing server, including the ability to subscribe and receive relevant transactions.

The Oracle Framework 100 provides a trusted point of integration for services to the distributed electronic ledger 82. Oracles subscribe to transactions they are interested in. They are used to call external services or automate transactions and other actions occurring across the network 80 on the distributed electronic ledger 82.

The Local Data Base module 102 is a database providing a location for retrieving information without having to make call to the blockchain through the Chain Application Programming Interface (API).

All transactions are populated from the messaging bus module 98 into the Local data Base module 102.

The Platform User Interface 106 is used by users to retrieve information for the Local Data Base module 102 and instigate the writing of transactions (where required) across the network 80 on the distributed ledger 82.

The Chain Web Application Programming Interface 108 is a restful API providing integration to the Blockchain module 92 of the processing server (node) 90. Typically, as is the case with other RESTful API's the Chain Web Application Programming Interface 108 is configured to use representational state transfer (HTTP request such as GET/POST to retrieve/modify Data) to avoid the need for installing additional software or libraries.

Advantageously, the Chain Web API is extremely flexible, such that the data in the distributed electronic ledger is not tied to specific resources or methods, but instead is able to handle multiple different type soft calls, data formats and has the ability to change structurally. Optionally the well-known .NET platform may be used to implement the Chain API.

Typically personal information such as the names and addresses of people, identity documents and other supporting documents may be stored in off-chain storage and not stored on the blockchain which is an immutable store. In a health insurance embodiment it would be appreciated that such documents may include medical records such as X-Rays or MRI scans or pathology results or receipts for storage etc.

Parties to information in the off-chain storage on another node are able to retrieve the document and replicate this to the off-chain storage on their node with this sharing of information facilitated by the processing server (node) 90 and the network 80. This off chain storage may be performed in an addressable file storage as is known in the art. Other approaches to transmission of the off-chain storage could also be employed without departing from the present disclosure.

Reference is made to FIG. 1c in which the approach for sharing of off chain documents is described. In the following embodiment a situation is discussed whereby a provider 20 has an X-Ray document 91 it needs to share with an insurer 70.

The processing server of the Provider 90 stores the relevant data (e.g. X-Ray data) using its own off-chain file storage module 96a. A location key for this data in this location is generated, as well as a mathematical hash. The processing server of the provider 90 creates a Document contract encrypted for itself and any insurers (in this case both insurer 1 and insurer 2) who need to receive the X-Ray documents and information. This document contract is transmitted to the other participants across the network 80 using the location as the key in a Document contract which is written to the distributed ledger 82.

Other participants (in this case insurers 70 who has the appropriate key) are now able to access the location of the X-ray data and replicate a copy on its own processing server (node) 70 in their own off-chain storage 96b. Provider 2 and Provider 3 insurer 4 do not have the appropriate key for decryption hence are not able to decrypt the location and access the X-Ray data.

After retrieval of the X-Ray data from the provider's off-chain storage 96a, the respective processing servers of the relevant insurer 70 is able to access the address may be configured to calculate a mathematical hash value. The processing server of the insurer 70 can then compare the calculated hash value with the hash result which was propagated in the Document Contract as on the distributed ledger 82 to verify the data has not been altered since it was originally stored at the specified location in off-chain storage 96a of the processing server 90 of Provider 1.

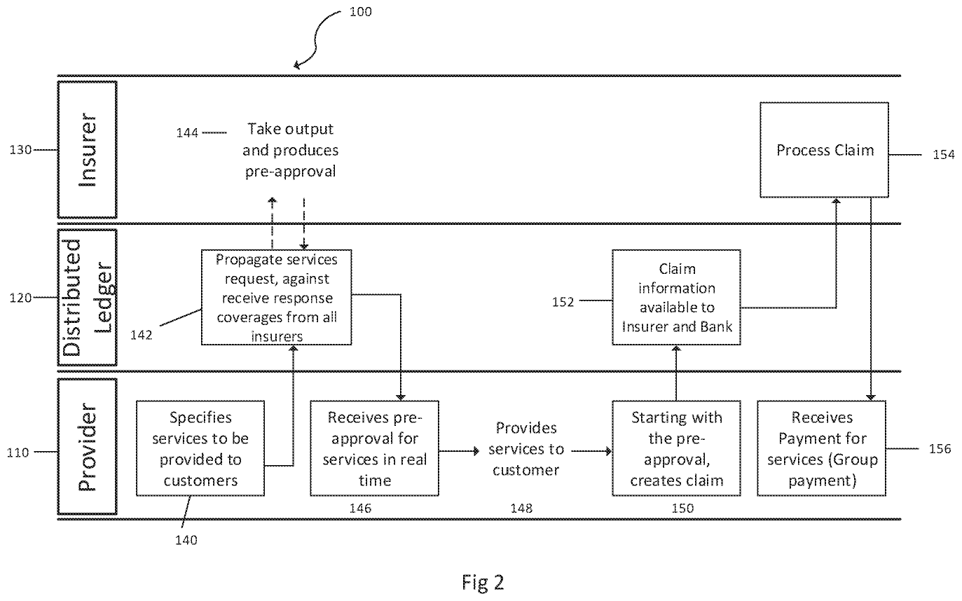

Referring now to FIG. 2, there is provided a high level abstract flow diagram for processing of pre-approval on the system for processing insurance transactions as described in the present disclosure. In the exemplary flow 100, the provider 110, distributed ledger 120 and insurer 130 are exemplary entities in the overall flow 100. It would be appreciated that these entities are advantageously selected from the entities represented in the embodiment of the system depicted in FIG. 1a.

In the flow depicted, a processor server of the provider 110 is used to specify in step 140 the services which are to be provided to customer.

This services contract is then transmitted to the distributed ledger 120 by the modules discussed above with reference to FIG. 1b, in step 142.

The distributed ledger 120 is accessible to all entities on the network including insurers, but only those insurers which have a provider agreement with that provider will receive the specific situation contract. The processing server of a relevant insurer identifies the request relates to a customer for which they have a policy based on a customer ID, and then accesses the potential coverage to be provided in step 144 to produce a pre-approval which is written back on the distributed ledger.

The change on the distributed ledger is monitored by the processing server of the provider and the pre-approval for the services is detected in real time by the processing server of the provider in step 146. The services may then be provided to the customer at step 148, with provider knowing they will be paid for the provision of such services.

At step 150, the provider, based upon the pre-approval provided previously, creates a claim request in step 150, which is then written to the distributed ledger in step 152. This claim is then available to the insurer (and potentially to a bank if they are part of the system).

At step 154, the claim specified on the distributed ledger is processed by the relevant insurer, and authorization is transmitted to the bank. This process is detailed in due course.

The ultimate outcome then effected is the provision of payment for the services provided to the customer being made by the bank to the relevant provider at step 156.

Advantageously, the system of the present disclosure is an electronic communication between interconnected processing service or nodes, to write the above transmissions on the blockchain. Information on this blockchain is accessible to the entities of that enquirers through the public and private key distribution and symmetric encryption, but at the same time is not accessible to persons outside the system, or insurers with whom a customer does not have coverage.

The system described in a high level form above significantly reduces the stages in processing of claims, eliminating many of the currently manual steps that are performed throughout this process, and at the same time provides an immutable record of the various transactions which take place which has been written to the distributed ledger 120. This is discussed in more detail below.

The following discussion is made with reference to a health care insurance scenario, where the services provided are treatments for specific conditions to a patient, however it would be appreciated that the same system could be used in other insurance context, for example, in the provision of automobile repair and employee compensation claims (by way of non-limiting example) instead of treatment services.

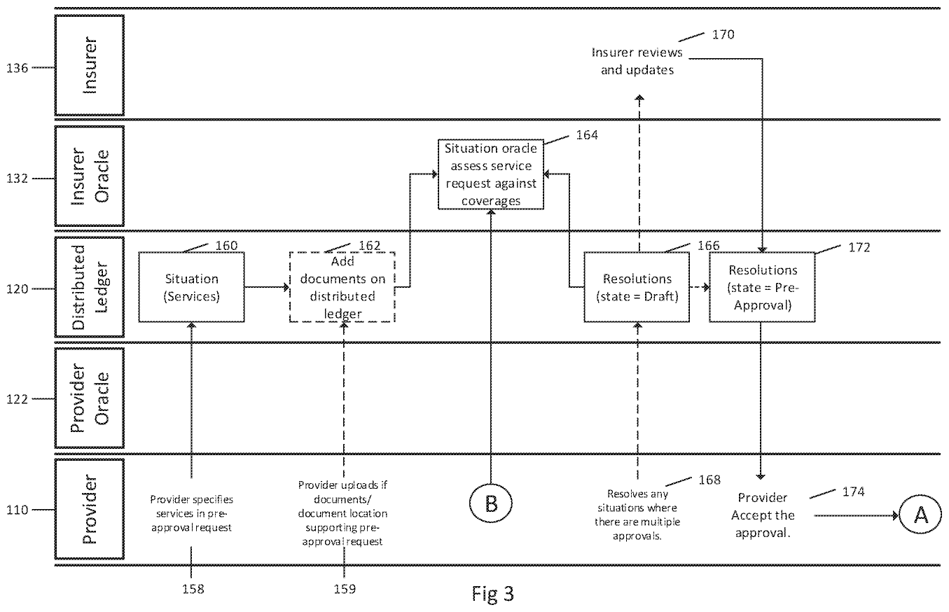

In the health care context depicted in FIG. 3 (which is an initial and more detailed explanation of the process described with reference to FIG. 2) a patient presents at a provider 110, in this case a hospital, for surgery.

Staff at the provider access a user interface, to specify services (treatments which are to be provided) in a pre-approval request or a Situation in step 158.

The processing server of the provider writes this service situation to the distributed ledger 120 in step 160 and may optionally include additional document locations on the distributed ledger in support of the patient services request in step 162. This may be provided as previously been described in the off-chain storage described in relation to FIG. 1c above.

It would be appreciated that the service situation contract in step 160 and any optional supporting document contract in step 162 on the distributed ledger 120 are encrypted.

Accordingly, when propagated on the distributed ledger, only the insurers with whom the provider 110 has a provider agreement concluded as stated in FIG. 1a, are able to view the contract.

It would be appreciated that due to the encryption, insurers without a provider agreement concluded with that specific provider will not know the patient is about to receive the treatment and is unable to retrieve the document contracts by decrypting the location specified therein.

At step 164, a situation oracle on the nodes of each of the insurers in the network detects the new service situation (in this case a treatment request for surgery).

Using the identification number of the customer (patient) the situation oracle of the insurer 132, assess or triages the service situation contracts on the blockchain against the potential coverages for all of the medical policies held by that insurer for that particular patient. As the insurance oracle is on the insurer's node, it is able to access all polices for all persons held by that insurer, matching the identification number of the customer (patient) for which the treatment/service Situation has been raised.

Once a patient has been identified, the situation oracle 132 of the insurer 136 is able to access all coverages for that person's policies held against the treatments/services which are specified in the service situation contract using the appropriate treatment mapping for that specific country or jurisdiction.

Assuming that the situation oracle 132 of the insurer 136 finds matching coverage for the service contract for the patient with the unique identification, it can search all of the previous claims against the appropriate coverage, to determine if that patient has a remaining benefit amount for that specific treatment type.

For example, it may be that the coverage provided to a particular patient in Hong Kong includes $1,000 for pathology per year and in this case the patient treatment may be for $500, which is less than the remaining balance of $600 for a particular patient after previous payments have been deducted.

Similarly, all of the available coverages held by an insurer for the patient if multiple insurance policies held by that particular customer or patient with the same insurer, can then be accessed or triaged and approval granted where there is benefit amount in excess of the amount claimed.

Where an insurer oracle 132 has assessed that treatment can be provided based upon the service situation contract, it can prepare a resolution, which specifies each treatment for the situation provided, and the amount of benefit the insurer will provide. This can be written to the distributed ledger 120 in step 166.

Optionally, where multiple resolution transaction exists (as represented by the dotted lines) for a situation, this may be written on the blockchain, and if necessary, managed by the provider 110 or the insurer, in the optional process steps 168 and 170.

Assuming that the resolution has been approved, such resolutions act as a form of pre-approval for the insurer for the provision of the services. In effect, these resolutions which are changed to a state of being pre-approved, will be written to the distributed ledger 120 and guarantee payment by the insurer for the services at the value nominated by the insurer in the resolution at 172.

It would be appreciated that the resolution of contracts are encrypted using the keys of the insurer 130 and the provider 110 such that the insurer is able to only access its own resolutions on the distributed ledger 120 although the provider 110 can access resolutions from all insurers which pertain to it.

Any amendments or clarifications may be manually inputted via the graphical user interface on the insurer's processing server in step 170, and also added to the distributed ledger 120 at step 172.

The provider processing server monitors the distributed ledger 120 for transactions which pertain to it, and identifies from the distributed ledger that a resolution has been added which can be accepted by the provider at step 174.

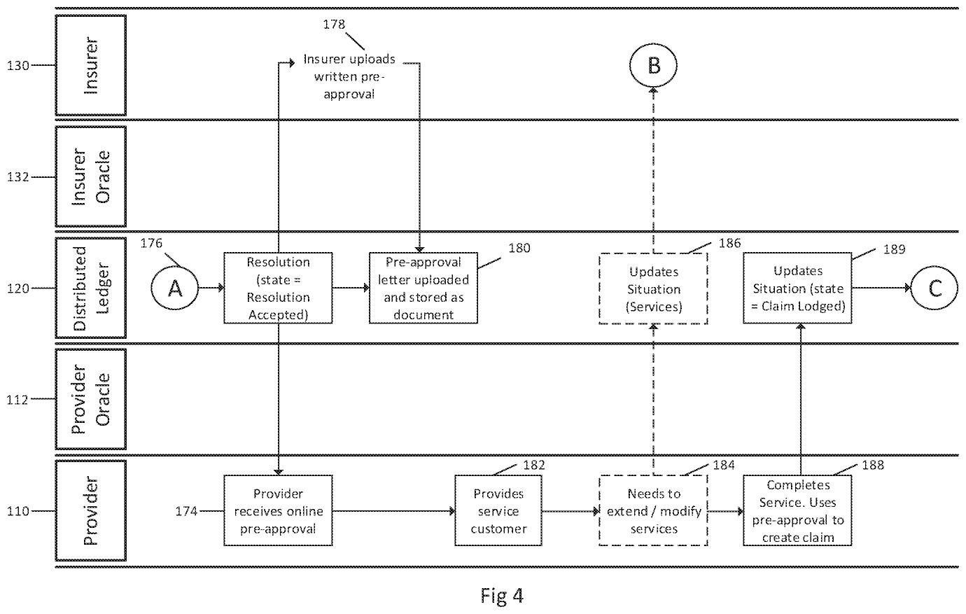

At step 174, a graphical user interface may present the provider with the resolution, and if there are multiple resolutions, the staff at the provider can consult with the customer in relation to which resolution is to be applied, accepting one resolution contract in its entirety or allocating amounts for different services (treatments) across the multiple resolution contracts. The acceptance of the resolution contract by the provider is promulgated on the distributed ledger 110 at step 176 as reference in FIG. 4.

As set out in step 178, an oracle on the insurer node of the processing server is uploads a written pre-approval in step 178 and this pre-approval letter may be uploaded and stored as a document in off-chain storage (as previously discussed) in step 180.

At step 182 (a specific instance of step 148 referred to in FIG. 2), the service or treatment is provided to the customer.

In an optional state, the provider may need to update the situation contract to reflect a change in the services being performed (treatments being offered). This update is propagated from the processing server of the provider 110 onto the distributed ledger 120 whereby it may be approved by the insurer by feeding back into the chain at item B on FIG. 3 for propagation as a draft/pre-approved resolution on the blockchain at step 186. This optional step is shown in dotted outline for ease of reference.

If there is no modification to the service (treatment) provided, the pre-approval can then be used to create a claim at Step 188 by the processing server of the provider, which is then written to the distributed ledger at Step 189 with a Situation with a state of a claim being lodged. It is possible to include additional documents either on the blockchain or in the off-chain storage at this time including the invoice for services.

Such documents may be additional document contracts replicated as previously described.

A claim may be generated for each insurer for whom the patient has an appropriate resolution. It would be appreciated by a person skilled in the art that claims are made up of multiple blockchain or distributed ledger contracts. Any Document contract which is associated with the specific services/situation contract will be replicated and attached to the claim contract. Any claim contract will be encrypted and will only be accessible by the insurer. The claim will be written to the blockchain from where it will be accessible to the insurer, and the situation contract states will be updated to reflect that the claim has been launched.

It would be appreciated that the situation would identify any treatment amounts on the user interface of the provider's processing server at the time at which the claim is created to identify any treatment amounts which are not covered by the patient's insurance policies. The provider is then able to collect the outstanding amount from the customer/patient before the services are finalized or the patient is discharged.

It would also be appreciated that claim contracts are associated to persons rather than to policies. Accordingly, a single claim can be applied to multiple polices by the allocation of the various items/services (treatments) that are within a claim contract of the coverage allocated for the particular policy. It would be appreciated that the claim process creation may be automated using the oracles 132 which are on the processing server or node of the insurer. The oracle takes the completed situation and resolution contracts and replicates this structure into a claim contract structure.

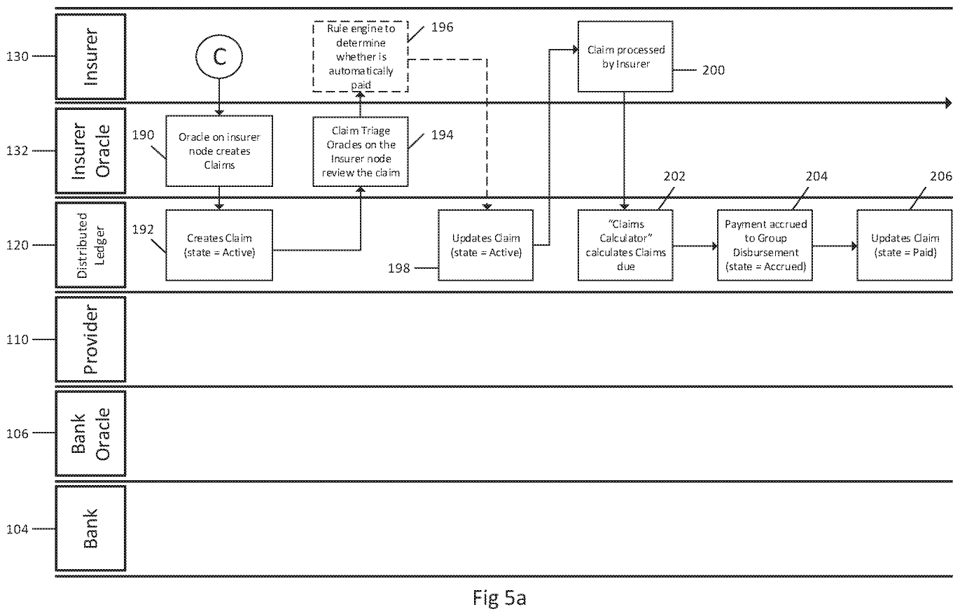

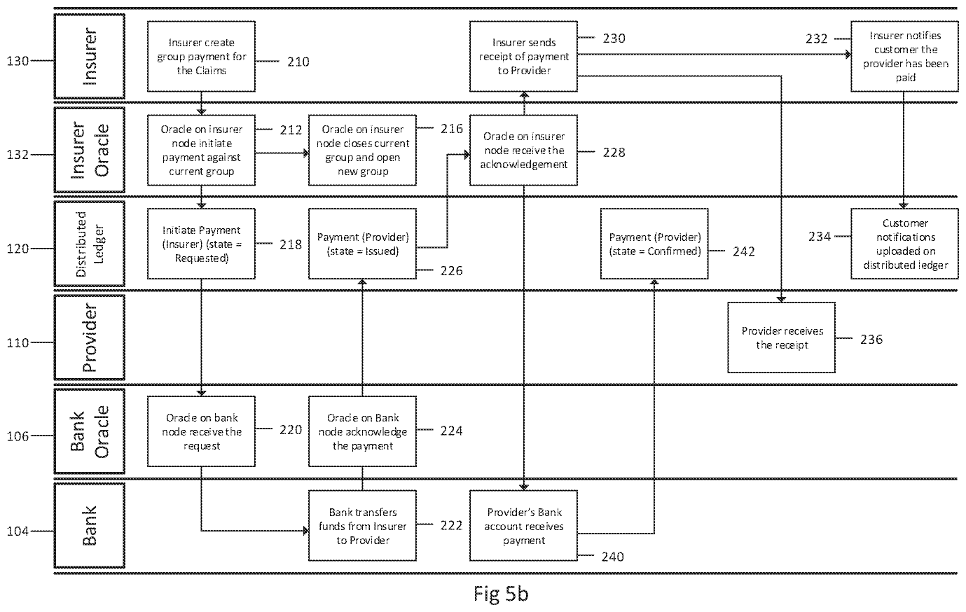

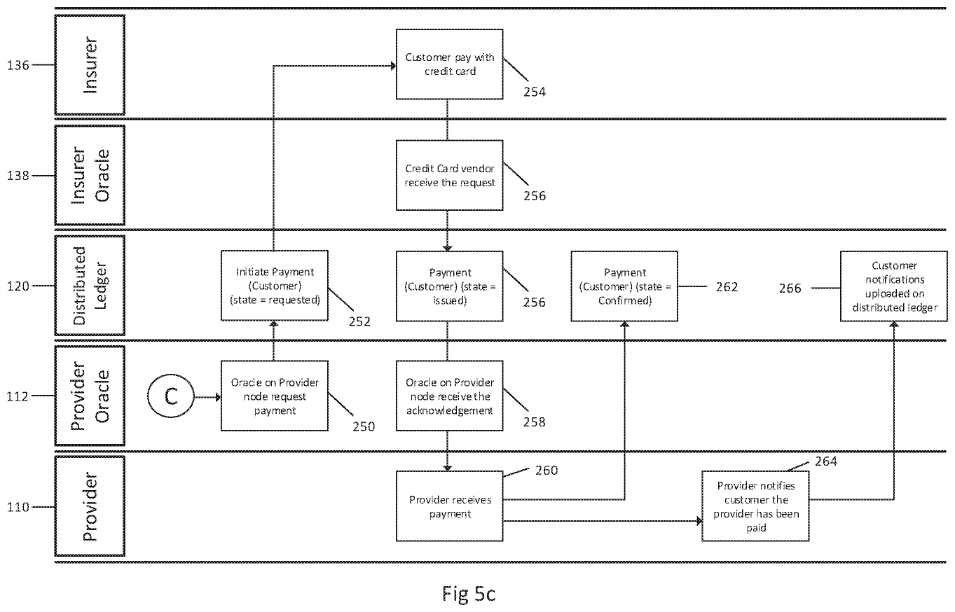

Now referring to FIG. 5a the oracle on the insurer node 134 detects the claim contract on the distributed ledger 120 from item C of FIG. 4 after step 189.

At step 190, the oracle of the insurer processing server or node creates a claim 190; and writes this claim to the distributed ledger 120 in step 192.

The active claim contract details may be detected by a claim triage oracle on the insurer processing node at step 194. This may be parsed by an external rules engine in step 196 on the insurer's oracle 132 to determine whether the claim can be paid automatically or requires further review. If the further review is required, in step 196, the rules engine may change the claim contract state to active.

Alternatively, as the situation services contract was already pre-authorized, the claim triage oracle on the insurer processing server may set the claim contracts to approved, setting the status as active at step 198.

On this basis, the active claim contracts may be processed by claim assessors at the insurer in step 200 using a user interface and once assessing has been completed this status may be set to approved state. A claim calculator 202 may then calculate the claims payments due at step 202.

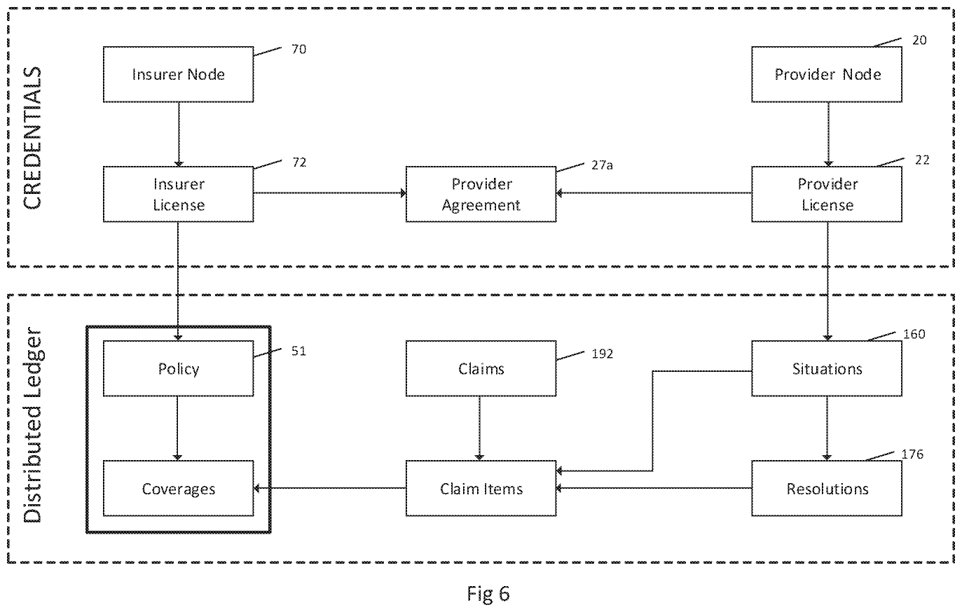

Payment contracts are created which may be accrued to a group disbursement in group 204, with such activity potentially being monitored by a payment oracle on the insurer's processing server which is monitoring the distributed ledger for claim contracts in an approved state. This is discussed in further detail with reference to FIG. 6.

Alternatively, a single payment may be made at step 206 and a transaction block showing the claim status as paid may be written to the distributed ledger 120.

Optionally the claim state may be set to paid, although it has actually been only accrued to the group disbursement and it will be settled according to the periodic payment schedule.

Referring now to FIG. 5b, there is depicted exemplary stages in the payment process for a group of accrual for payment of claims, in more detail.

At step 210, once a claim will be paid (e.g. at step 204 of FIG. 5a) the insurer may create a group payment for multiple claims rather than paying one-by-one. An oracle on the insurer node then initiates payment for the current group disbursement in step 212 periodically at a pre-determined frequency. It would be appreciated that a disbursement can be made up of multiple payment for services provided by a service provider. These payments may be payments to the medical providers and to the policy owner themselves.

It would be appreciated that payment to medical providers can be accrued for periodic settlements, ideally by a group disbursement contract which may be attached to the provider agreement contract. Typically, such individual payment contracts will be attached to the group disbursement contract in an accrued state. Periodically, as depicted at step 216, the oracle on the insurer's node process the current group and open a new group disbursement account, and step 218 sets the initiate payment by changing the state for the group disbursement to a requested state. A new group disbursement contract is then opened for the next time period in step 216.

A bank oracle 108 on the bank processing server 104 may then be monitoring the distributed ledger 120 and note that the group payment contract has a state of requested, with that request received in step 220. Optionally, the payments may be made in a number of different ways as depicted.

Where the provider 110 has a relationship with a bank 104 which has oracle 106 which is monitoring the blockchain 120, then as depicted in FIG. 5b, the payment contract may be encrypted so that it can be accessed by both the insurer and the bank.

As shown at step 222, once the bank transfers funds from the insurer to the provider the oracle on the bank node acknowledges payment at step 224.

The oracle on the bank node then updates the statement of payment to the provider to a state of issued at step 226 and appends or writes this transaction to the ledger.

This transaction may then be detected by an insurer oracle in step 228; triggering the issuance of a receipt for payment 230 being sent from the insurer to the provider. Optionally, a notification is also sent to the customer that the provider has been paid at step 232. This customer notification may be then propagated onto the blockchain at step 234.

Optionally, the receipt may be transmitted at the same time to the provider at step 236 indicating payment.

Once the provider's bank account receives the payment at step 240, the transaction may then be written to the distributed ledger 120 to confirm that the payment has been received by the provider from the insurer.

Referring now to FIG. 5c, there is discussed an exemplary stage in the payment of some non-covered options for services of a provider, which will not fall within the coverage of an insured.

At step 250, processing server of a provider may receive a request for payment, and the distributed ledger 120 is then updated with an appended transaction to indicate that payment has been requested at 252.

At step 254, the customer indicates that they wish to pay the amount with a credit card.

In this case, at step 256, the credit card vendor receives the request and the distributed ledger 120 is updated with an appended transaction to indicate that the payment to the customer has been issued.

At step 258 the oracle on the provider node receives the acknowledgement that payment to the customer has been issued.

Once the provider receives the payment from the credit card company 260 and updates the distributed ledger by appending a transaction with a notification that the payment has been received and confirmed from the customer at step 262.

At the same time, the provider notifies the customer that the provider has been paid at step 264 and the customer notification is uploaded to the distributed ledger 266.

Referring to FIG. 6, there is depicted in more detail the separation of data and access rights of the system depicted in the embodiment of the disclosure shown in FIG. 1a.

As can be appreciated, the relationship between the insurer and the provider is dictated by a provider agreement 27a which draws upon the provider license 22 and the insurer license 72.

As has been discussed with reference to FIG. 1a, the specific provider agreement concluded between the specific insurer and the specific provider is accessible only to these entities with access controlled through appropriate encryption.

However, it would be appreciated that the insurer license and the provider license 22 are both accessible to all entities on the system.

As noted above with reference to FIG. 1a, each insurer entity on the platform has an insurer license which defines the operation of jurisdiction and the product types that the insurers are licensed to sell in that specific jurisdiction. In this way, the credentials of the insurer and the provider can be mutually established.

Information written to the distributed ledger is segregated from the other entities in the system. The specific policy 51 is issued for a particular structure of contracts. These contracts pertain to particular products which specify all of the information for the insurer's coverages in that product.

A specific policy 51 therefore has associated coverages with the requisite terms and conditions appropriate for that particular product type that is offered by that specific insurer.

Importantly, when the policy and the associated coverages are written to the distributed ledger, they are encrypted and are not accessible to a provider. They remain accessible to the insurer who has the corresponding key for decryption.

The specific claim 192 has associated claims items which are associated with a particular person and may be covered by multiple policies. Specific situations (services requests) of the specific person are associated with resolutions 176. These resolutions may in turn become actual claims once approved by an insurer following assessment against the coverages of a policy for a specific individual by that insurer.

Accordingly, the present system provides a way in which the distributed ledger facilitates the transformation of situations to resolutions and claim items, at the same time segregating access to data so that providers are unable to determine the potential scope of coverage available but at the same time all of the necessary information of a specific insured person is accessible by the insurer, including their past claims history, which may also be written to the distributed ledger.

Providers have visibilities over the resolutions, which is required in order to provide the services requested, but are unable to determine exactly how much is left in a coverage for a specified individual under a policy for a specific insured.

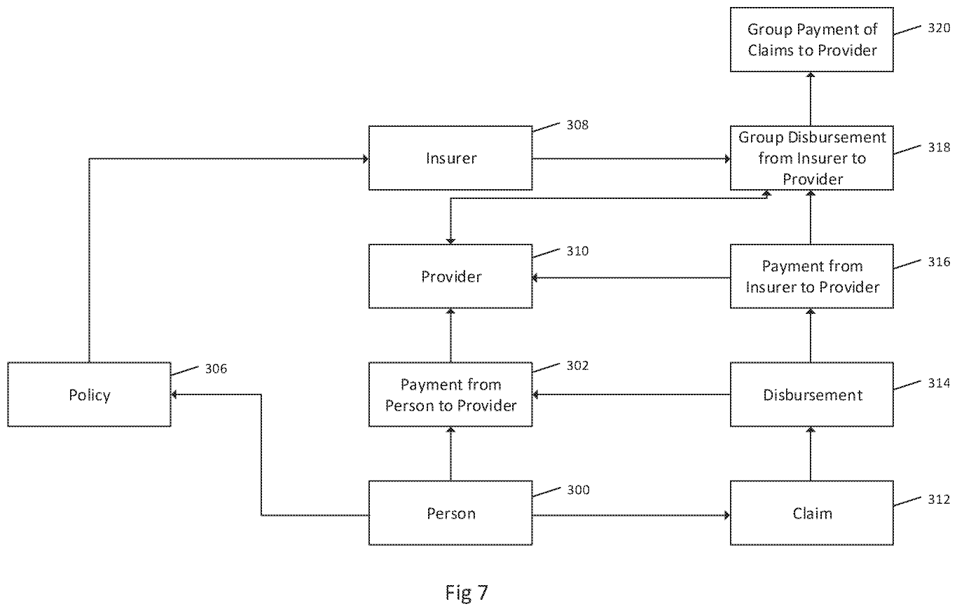

Accordingly, the segregation of data facilitated by encryption and document exchange disclosed above provides an immutable yet flexible approach for managing the progression of situations resolutions and claims of a specific individual for a specific provider in a system of insurers and providers in a general insurance context using a distributed ledger. Referring now to FIG. 7, there is depicted a typical group of contracts used in the optional payment aspect of the present disclosure.

As shown, payment may be made directly from the person 300 to the provider 310 directly as shown in the payment flow 302.

Alternatively, the service may be provided under a claim 312 which has a disbursement 314 associated therewith and these disbursements may be paid individually 316 and may comprise multiple payments. Alternatively, as shown at 318, the disbursements may be paid in a group of disbursements paid by the insurer to the provider. Similarly, there may be a group payment of claims to the provider 320. Again, this is merely an exemplary way in which payment may be effected, according to the various smart contracts and payment arrangements made between the various entities of the platform.

Advantageously, the present system and service are configured to automate a substantial amount of the transactions, using a distributed blockchain ledger. These transactions are made by adding blocks to the distributed ledger, with supporting documents accessible as has been hereinbefore described.

Being able to access the requisite information enables providers to have surety that they will be paid before performing a service, while at the same time the amount of coverage potentially available to an insured person is not accessible to that provider. This avoids a situation where a provider can claim the maximum amount possible and exhaust an insurer's coverage by knowing the maximum amount benefit limit potentially available.

The assessment from an individual's service request against a corresponding policy, grant of pre-approval, and transformation of this pre-approval into a resolution which can be accepted by a provider to become a claim significantly reduces the number of stages and processes required in an insurance environment.

Electronic cryptographic techniques available in the system provide increased data security as compared to a centralized system, and once established, the present system and approach offers a significant streamlining, potentially being able to occur in real time.

For example, a patient receiving a treatment can submit a service request at a provider, and this treatment request can be processed, approved while the patient is either undergoing the treatment or shortly thereafter and before they depart the services provider (e.g. doctor's surgery) premises. This system enables providers to receive payment at a much earlier time than under a traditional system, reducing the dwell time of the insurance claims.

The selective visibility of information to the entity sharing the platform to electronic cryptographic storage and techniques ensures that supporting documents are available, but information is restricted in its availability. Accordingly, the present architecture provides an efficient, scalable system for the processing of insurance claims.

Importantly, it would be appreciated in the system and method of the present disclosure; the elements of the information are distributed using the distributed electronic ledger. There is no centralised store of information vulnerable to hacking in the arrangement of the present disclosure.

The above embodiments are described by way of example only. Many variations are possible without departing from the scope of the disclosure as defined in the appended claims.

For clarity of explanation, in some instances the present technology may be presented as including individual functional blocks including functional blocks comprising devices, device components, steps or routines in a method embodied in software, or combinations of hardware and software.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, Universal Serial Bus (USB) devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A system for processing insurance transactions comprising:
at least one provider processing server configured for storing at least one or more encrypted agreements with at least one insurer for the payment for the provision of a plurality of specified services to customers; wherein the at least one provider processing server is further configured for appending to a distributed electronic ledger an encrypted customer service request upon receiving a request by a customer having a unique identifier for at least one of the specified services;
at least one insurer processing server for receiving and electronically storing an encrypted insurance policy for a customer with a unique identifier wherein said policy covers provision of a plurality of predefined services; the insurer processing server being configured for monitoring the distributed electronic ledger and detecting a customer service request for a customer from a provider with whom that insurer has an encrypted agreement; and upon identification in an insurance policy for the specified customer of coverage for the specified services in the customer service request, appending an encrypted approval transaction to the distributed electronic ledger.

2. A system for processing insurance transactions according to claim 1 wherein the provider processing server is configured for encryption of the agreements with a private key.

3. A system for processing insurance transactions according to either claim 1 wherein the insurer processing server is configured for encrypting the insurance policy with customers with a private key.

4. A system for processing insurance transactions according to claim 1 wherein the provider is a health services provider and the customer is a patient of the provider.

5. A system for processing insurance transactions according to claim 1 wherein the insurer processing server is configured to analyse benefit history following identification in an insurance policy for the specified customer to confirm coverage for the specified services prior to approval of the request for services.

6. A system for processing insurance transactions according to claim 1 wherein the coverage for specified services is confirmed after reviewing the benefits already claimed under the insurance policy for the specified customer.

7. A system for processing insurance transactions according to claim 1 wherein the provider processing server is configured for detecting and decrypting approvals from a plurality of insurers having encrypted contracts with that provider, said approvals being for a customer of the specified services being appended to the distributed electronic ledger.

8. A system for processing insurance transactions according to claim 1 wherein the encrypted agreements are concluded from an unencrypted master agreement accessible across a computer network.

9. A system for processing insurance transactions according to claim 1 wherein provider modification to a customer service request is encrypted prior to appending to the distributed electronic ledger for approval by at least one insurer processing server against the policy for the provision of a plurality of predefined services of the customer having the unique identifier.

10. A system for processing insurance transactions according to claim 1 wherein the insurer processing server is further configured for generating an encrypted claim from the approval of the provider for appending to the distributed electronic ledger.

11. A system for processing insurance transactions according to claim 10 wherein the encrypted claim is reviewed by the insurer prior to being assigned for payment.

12. A system for processing insurance transactions according to claim 1 wherein the encrypted claim includes at least one or more encrypted documents associated with the claim whereby the location of these documents is propagated via appending to the distributed ledger.

13. A system for processing insurance transactions according to claim 12 wherein the documents are downloaded and verified by the insurer's processing server.

14. A system for processing insurance transactions according to claim 1 wherein the information on the distributed ledger originating from a provider for a specific insurer is able to be decrypted only by that insurer with a corresponding private encryption key and wherein the provider is unable to access policy information for the customer having the unique identifier.

15. A system for processing insurance transactions according to claim 1 wherein the encrypted claim is paid by the insurer module of the processing server.

16. A system for processing insurance transactions according to claim 1 wherein a processing server is configured to accrue a plurality of encrypted claims for a specific insurer of a plurality of insurers for consolidated payment thereof.

17. A system for processing insurance transactions according to claim 1 further comprising a bank payment server coupled to the computer system via a communications network configured for receiving a payment request from an insurer for transfer of funds.

18. A service provider processing server of a system for processing insurance transactions, the processing server comprising:
at least one storage module for storing at least one or more encrypted agreements by the provider with at least one insurer for the payment for the provision of a plurality of specified services to customers,
a user interface for receiving a request from a customer having a unique identifier for at least one of the specified services,
a distributed ledger interface module for updating a distributed electronic ledger with an customer service request which has been encrypted by an encryption module,
wherein the distributed ledger interface module is further configured to monitor the distributed electronic ledger so as to detect an encrypted approval of the customer service request from an insurer processing server.

19. The service provider processing server according to claim 18 wherein the processing server is configured for detecting and decrypting approvals from a plurality of insurers having encrypted contracts with that provider, said approvals being for a customer of the specified services appended to the distributed electronic ledger.

20. The service provider processing server according to claim 19 wherein provider modification to a customer service request is encrypted prior to updating of the distributed electronic ledger for approval by at least one insurer processing server against the policy for the provision of a plurality of predefined services of the customer having the unique identifier.

21. An insurer processing server in a system for processing insurance transactions, the insurer processing server comprising:
at least one storage module for receiving and electronically storing an encrypted insurance policy for a customer with a unique identifier wherein said policy covers provision of a plurality of predefined services;
a distributed ledger interface module for detecting a customer service request in a distributed ledger for a customer from a provider with whom that insurer has an encrypted agreement; and upon identification in an insurance policy for the specified customer of coverage for the specified services in the customer service request, being configured for appending to the distributed electronic ledger with an encrypted approval transaction.

22. The insurer processing server in a system for processing insurance transactions according to claim 21 further comprising a user interface module for manually approving a customer service request for a customer having a unique identifier upon identification in an insurance policy for the specified customer of coverage for the specified services in the customer service request.

23. The insurer processing server in a system for processing insurance transactions according to claim 21 wherein the processor of the insurer processing server is configured to analyse benefit history following identification in an insurance policy for the specified customer to confirm coverage for the specified services prior to approval of the request for services.

24. The insurer processing server according to claim 21 wherein the insurer processing server is further configured for generating an encrypted claim from the approval of the provider detected on the distributed electronic ledger and writing the encrypted claim thereto.

25. The insurer processing server according to claim 21 wherein the encrypted claim is reviewed by the insurer prior to being assigned for payment.

26. The insurer processing server according to claim 21 wherein the encrypted claim includes at least one or more encrypted documents associated with the claim whereby the location of these documents is propagated via appending to the distributed ledger.

27. The insurer processing server according to claim 26 wherein the documents are downloaded and verified by the insurer's processing server.

28. The insurer processing server according to claim 21 wherein the information on the distributed ledger originating from a provider for the insurer is able to be decrypted only with a corresponding private encryption key held by the insurer and wherein the provider is unable to access policy information for the customer having the unique identifier.

29. The insurer processing server according to claim 21 wherein a payment processing server is configured to accrue a plurality of encrypted claims for that insurer prior to payment at a predetermined time.

30. (canceled)
